(19) United States
(12) Patent Application Publication
(10) Pub. No.: US 2009/0255864 A1
(43) Pub. Date: Oct. 15, 2009

(54) Anti-microbial carrier member for storm water systems

(76) Inventors: Mark D. Shaw, Ponte Vedra Beach, FL (US); J. Tad Heyman, Atlantic Beach, FL (US); Laurence M. Bierce, Steinhatchee, FL (US)

Correspondence Address: ROGERS TOWERS, P.A., 1301 RIVERPLACE BOULEVARD, SUITE 1500, JACKSONVILLE, FL, 32207, US

(21) Appl. No.: 12/454,583

(22) Filed: May 20, 2009

Related U.S. Application Data
(63) Continuation-in-part of application No. 11/488,220, filed on Jul. 18, 2006.
(60) Provisional application No. 60/700,279, filed on Jul. 18, 2005.

(51) Int. Cl. C02F 1/50

(52) U.S. Cl. 210/170.03; 210/198.1

(57) ABSTRACT

A storm water drainage system anti-microbial device disposed in a sump of the storm water system such that the concentration of bacteria in storm water that remains resident in the sump after a storm event is severely reduced or eradicated. The device has a plurality of strips or similar carrier members depending from a mounting member or a floatation member.

This application is a continuation-in-part of U.S. Non-provisional patent application Ser. No. 11/488,220, filed Jul. 18, 2006, which claims the benefit of U.S. Provisional Patent Application Ser. No. 60/700,279, filed Jul. 18, 2005.

### BACKGROUND OF THE INVENTION

This invention relates generally to the field of storm water drainage systems, and in particular treatment of storm water run-off as captured, controlled and transported by storm water drainage systems. More particularly, the invention relates to the field of means to treat non-flowing or resident storm water retained within the storm water system between storm events to eradicate bacteria.

As a result of society's high level of use of products containing hydrocarbons, organic liquids, phosphates, nitrates, heavy metals and other environmentally hazardous materials and chemicals, it is not uncommon for such components to be flushed in significant amounts into storm water drainage systems. It is therefore desirable to provide means and methods to remove such contaminants, in addition to the standard particulate and solid matter that is picked up, from the storm water prior to discharge of the storm water from the storm water system. In a common approach filtration means capable of capturing the contaminants are disposed at the ingress points of the storm water system, i.e., filter means are positioned in the storm drains such that the contaminants are immediately captured and storm water passing into the storm water drainage system is relatively contaminant-free, which are often referred to as catch basin filters. In another method, filtration means are positioned at the points of exit of the storm water system, such that the contaminants are removed prior to discharge into the environment. A typical storm drain comprises a surface opening covered by a grate, a curb inlet, or a combination of the two, where the surface opening leads directly into a catch basin, usually of a rectangular or cylindrical shape, that has a sump that allows particulates to settle. An outlet pipe connects to the catch basin above the sump and directs the storm water through other conduits and temporary retention chambers or vaults to a point of treatment or discharge.

Another problem inherent in storm water discharge is microbial contamination. Significant microbial contamination of discharge water results from the fact that storm water systems comprise vast networks of storm drains, conduits, collectors, vaults, chambers and the like, and all of the storm water entering a storm water system does not immediately pass through the system. Instead there are large numbers of areas where portions of the storm water remain resident in the system for extended periods of time. For example, the outlet pipes at the base of storm drains is typically connected to the catch basin several inches above the bottom of the basin to create a sump area to entrap sediments and other solid matter. This results in several inches of water that remaining trapped in the bottom or sump of each catch basin after a storm. Likewise, underground filtration chambers or vaults are often incorporated into the storm water systems to entrap sediment and other solid matter, the chambers or vaults also defining sumps that retain resident water for extended periods of time between storm events. This resident water is a prime breeding ground for bacteria, and over time the bacteria in the sumps multiply exponentially, especially due to the phosphates, nitrates and other nutrient contaminants present in the storm water run-off. When the next storm occurs the resident water in the catch basins is flushed and the bacterial concentration discharging from the storm system may exceed safe limits. In addition, the bacterial contamination of the resident sump water can result in odor and blockage problems.

Providing anti-microbial agents as a component of suspended filtration media at the ingress points of the storm system, i.e., in the storm grates or curb inlets, such that the inflowing water contacts the anti-microbial agents, does not solve this problem, as the amount of time that the bacteria is in contact with the anti-microbial agents in these pass-through catch basin filters is extremely short, and thus the effectiveness of the anti-microbial action is very limited if not completely ineffective. Because the anti-microbial agents are positioned above the sump area, they have no effect on bacterial growth in the resident water in the catch basin or in other components of the system. It is also important that any anti-microbial agents utilized to attack bacteria, mold, viruses and the like be environmentally safe, since the treated water is discharged back into the environment.

It is an object of this invention therefore, to provide a means for effectively reducing the bacterial concentration in storm water discharge. This is accomplished by providing an anti-microbial carrier member that effectively reduces or eradicates the concentration of bacteria in storm water that remains resident in sump areas of a storm water system. The anti-microbial carrier member is at least partially disposed in the resident water within the storm water system elements, thereby increasing the contact time between the anti-microbial agents and the bacteria such that large amounts of bacteria are eradicated and explosive bacterial growth within the sump areas is precluded. It is a further object to provide such anti-microbial carrier members composed of a filter material that removes other contaminants from the resident water, such as hydrocarbons, liquid organics, phosphates, nitrates, heavy metals and the like.

### SUMMARY OF THE INVENTION

Bacterial discharge from a storm water system is eradicated or severely reduced in concentration by placing an anti-microbial device within the sump areas of the storm water system. The anti-microbial carrier device is disposed in the resident water within the sumps of the system, thereby increasing the contact time between the anti-microbial agents and the bacteria such that large amounts of bacteria are eradicated and explosive bacterial growth within the sump areas is precluded prior to such bacteria being flushed from the system during the next storm event. The anti-microbial agent is adhered to, combined with, or impregnated in a carrier member, or disposed as blocks, granules, beads or the like retained by pockets in a carrier member, or otherwise joined to or retained by the carrier member.

In one embodiment the invention comprises a mounting member that is affixed or mounted to the storm water sump, the mounting member suspending a carrier member into the resident water in the sump, the carrier member comprising one or more elongated depending members, preferably of sufficient length to reach to or near the bottom of the sump area when the water level of the resident water is at its highest. The depending members are carriers for an anti-microbial agent. The ends of the depending members may be weighted, tethered or otherwise secured such that they will extend and remain beneath the surface of the resident water. Preferably, the depending members are composed of a filtration medium that removes hydrocarbons, organic liquids and other contaminants from the resident water, but the depending members may be composed of any suitable matrix or carrier material to support the anti-microbial agent.

In the preferred embodiment the invention is a buoyant floating device such that the anti-microbial carrier member remains at or beneath the surface level of the resident water for the entire period during which no water flow occurs through the storm water system. Attached to a floatation means, the carrier member comprises one or more depending members, preferably of sufficient length to reach to or near the bottom of the sump area when the water level of the resident water is at its highest. The depending members are carriers for an anti-microbial agent. The ends of the depending members may be weighted, tethered or otherwise secured such that they will extend and remain beneath the surface of the resident water. Preferably, the depending members are composed of a filtration medium that removes hydrocarbons, organic liquids and other contaminants from the resident water, but the depending members may be composed of any suitable matrix or carrier material to support the anti-microbial agent.

### BRIEF DESCRIPTION OF THE DRAWINGS

FIG. 1 is an embodiment of the invention, showing the anti-microbial device having a floating collar member.

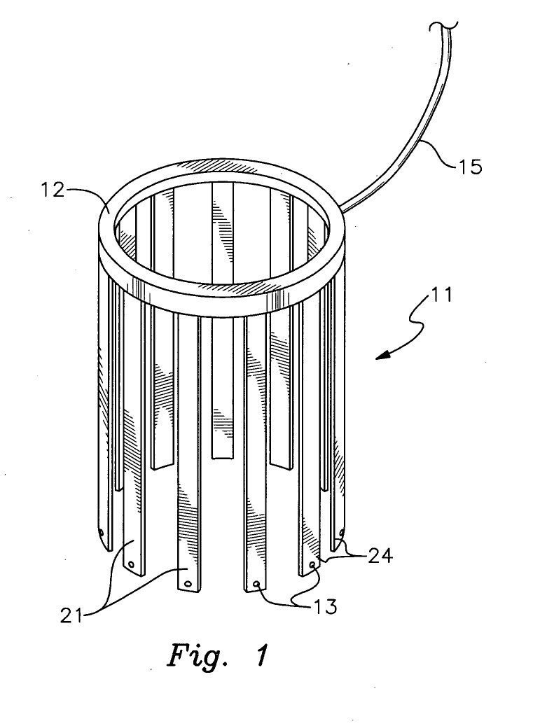

FIG. 2 is an alternative embodiment of the invention, showing the anti-microbial device having an elongated floatation member.

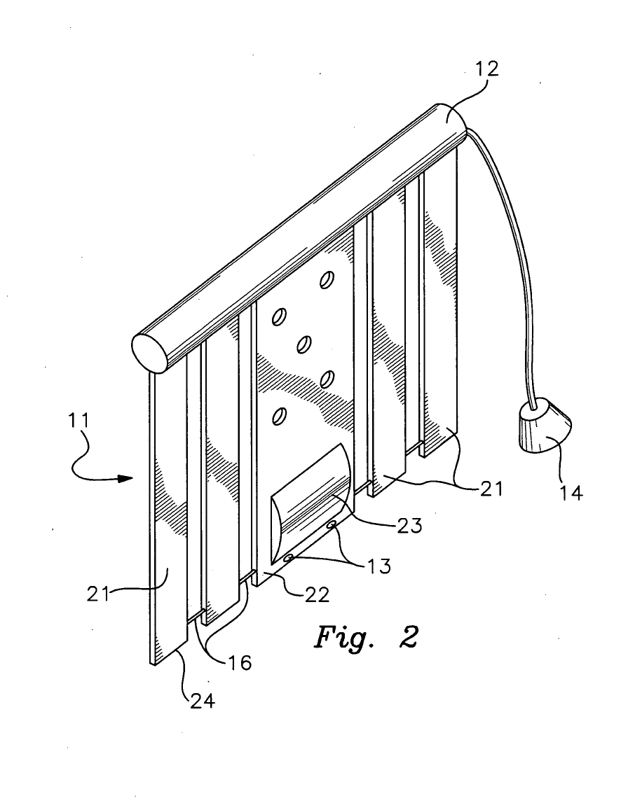

FIG. 3 is an alternative embodiment of the invention, showing the anti-microbial device mounted to the storm water sump.

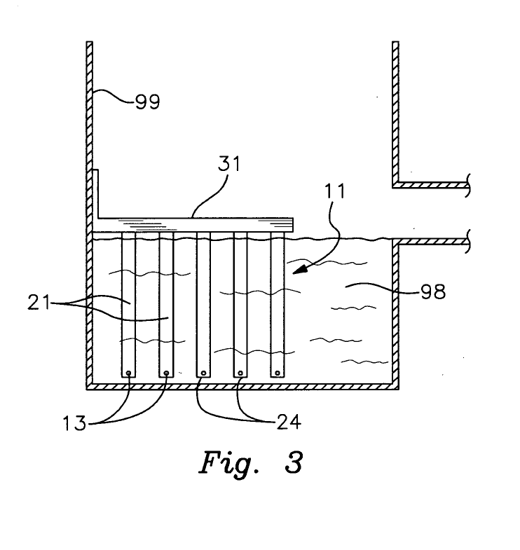

### DETAILED DESCRIPTION OF THE INVENTION

The invention is in general an anti-microbial means for severely reducing or eliminating bacterial contamination of storm water within and discharging from a storm water system into the environment, wherein the anti-microbial device comprises elements that remain in contact with water resident in sumps in the storm water system, such as found in the bottom of catch basins and underground filtration or detention storage vaults or chambers.

Storm water systems are well known and extremely common, typically consisting of large of numbers of storm drains located in roadways, curbs, large paved areas such as parking lots, drainage ditches and the like. The storm drains allow the storm water to fall through surface openings, usually covered by grates, and into structures known as catch basins. Outlet conduits are connected to the catch basins to transport the storm water to discharge points where the storm water is returned to the environment. A storm water system is a vast network, and there are numerous components or areas that act as reservoirs or sumps, either intentionally or unintentionally, where storm water remains resident within the system for extended periods of time, or at least until flushed out by a subsequent storm event. For example, sumps are provided in the catch basins to allow larger solids or other matter to settle, and are created in typical manner simply by connecting the outlet conduits several inches or more above the bottom of the catch basin.

Because the water often remains in these sumps for extended periods of time between storm events, and because the sumps will not necessarily be completely flushed upon subsequent storm events, the water retained in the sumps is prime for bacterial growth. This can result in an extremely high bacterial concentration in the discharge water when flushing of the storm system occurs.

The invention solves this problem by providing an anti-microbial device that has elements adapted so as to be positioned within the retained water of a storm water sump when the anti-microbial device is put in use as a resident treatment means for the non-flowing, standing or resident water within the storm water system.

The anti-microbial device comprises an anti-microbial carrier means 11 for retaining an anti-microbial agent and an anti-microbial agent associated with the carrier means 11. The anti-microbial agent may be any of many suitable compositions, such as for example but not limited to an organosilane antimicrobial agent as disclosed in U.S. Pat. No. 5,954,869, the disclosure of which is incorporated herein by reference. The anti-microbial agent is suitably bonded, adhered, grafted, impregnated or otherwise joined to the material composing the carrier means 11, such as for example disclosed in the above referenced patent, or the anti-microbial agent may be of solid form or suitably bonded, adhered, grafted, impregnated or otherwise joined to other carrier materials that are then attached to, retained by or contained within pockets formed in the carrier means material. The term anti-microbial is meant herein to include any compound, product, composition, article, etc., that reduces the growth and proliferation of microbial organisms, including but not limited to bacteria, viruses, protozoa, molds and the like.

Preferably the carrier means 11 is flexible and composed of a material formed with a large number of interstitial voids or openings in order to provide a device with a relatively large surface area in relation to its overall dimensions. The carrier means 11 may be composed of fabrics or mats of loose or interwoven polymer fibers, sponge or sponge-like material, synthetic foams, etc. It is most preferable that the material composing the carrier means also act as an effective means to adsorb hydrocarbon and liquid organic contaminants, as the presence of these components in discharge water is also undesirable. Many known polymers, for example and not to be limiting, such as polypropylenes or polyesters exhibit this property. The material may also be of a type to adsorb heavy metals, phosphates, nitrates, etc., and multiple material layers may be utilized to target specific contaminants.

The anti-microbial device may be attached or secured in some manner to the structural elements defining the sump 99, such as the walls or top of a catch basin, chamber or vault, such that at least a portion of the carrier means 11 is positioned in the sump 99 so as to make contact with the resident water 98. In one embodiment, the device comprises a structural mounting member 31 that is affixed to or retained in some manner by the storm water sump 99. One or more anti-microbial carrier means 11 are attached to or retained by mounting member 31. The carrier means 11 are preferably elongated fingers or strip members 21 that depend from the mounting member 31 so as to reside in the resident water 98 within the sump 99, the strip members having distal ends 24. The distal ends 24 of the carrier means 11 are weighted or tethered such that the strip members 21 hang into the resident water 98 rather than floating on top.

In a preferred embodiment, the anti-microbial device is as buoyant device and comprises floatation means 12 for floating the device on the surface of the resident water 98 within a sump 99, such as a member comprising a buoyant material, air chambers or the like, and at least one and preferably plural anti-microbial carrier means 11, such as elongated fingers or strip members 21 depending therefrom. Preferably, weights 13 are attached to maintain the ends 24 of the strips 21 toward the bottom of the sump 99. The floatation means 12 of the anti-microbial device is sized sufficiently large to preclude passage into an outflow conduit, anchored by an anchor 14, or tethered by a tether 15 such that it remains entrapped in the chosen sump area 99 during storm water discharge events, i.e., when sufficient storm water passes into and through the storm water system to flush some or all of the resident water from the sumps 99. The configuration of the floatation means 12 may vary. It is most preferred that some of the material of composition of the floatation means 12 also be of the type that removes hydrocarbons, organic liquids and other contaminants from the storm water.

One or more anti-microbial carrier members 11 are connected to the floatation means 12, whereby at least a portion of the anti-microbial carrier members 11 extend into or reside in the resident water 98 in the sump area 99. An anti-microbial agent is adhered to, combined with, or impregnated in the material composing the anti-microbial carrier members 11, or disposed as blocks, granules, beads or the like retained by pockets 23 in the anti-microbial carrier members 11, or otherwise joined to or retained by the anti-microbial carrier members 11. Most preferably, the anti-microbial agent is permanently adhered to or retained by the anti-microbial carrier members 11, such that the anti-microbial agent does not disperse into or contaminant the resident water 98, but instead direct contact by bacteria and the like with the anti-microbial carrier members 11 is required for destruction of the bacteria and other organisms.

While the size and configuration of the anti-microbial carrier members 11 may vary greatly and no single size or configuration is required for efficacy, maximizing the surface area of the anti-microbial carrier members 11 and maximizing the amount of interstitial spaces within the material of composition is beneficial. In a preferred embodiment, the anti-microbial carrier members 11 comprise a plurality of strips or finger members 21 depending from the floatation means 12, the depending strips 21 preferably being of sufficient length such that their distal ends 24 reach to or near the bottom of the sump 99 when the maximum depth of resident water 98 is present. The strips 21 are provided with weights 13 such that the ends 24 of the strips 21 reside within the resident water 98 rather than floating on top of the resident water 98 if the strips 21 are inherently buoyant. The distal ends 24 of the strips 21 may be connected to each other flexibly or rigidly by connector means 16, such as with ropes, chains, rods or the like, so as to maintain a desired configuration. The anti-microbial carrier members 11 may be provided in any configuration, such as gapped as shown, edge-to-edge, overlapping, etc., may be provided as panel or sheet members 22, may be slit in multiple directions such as to create a feathered effect, or may be perforated or otherwise configured to define additional flow paths for the bacteria containing water to contact the anti-microbial agent.

The anti-microbial device is left in the sump 99 until its anti-microbial effectiveness becomes diminished, at which time it is cleaned and replaced or a new anti-microbial device is substituted.

It is understood and anticipated that equivalents and substitutions for certain elements described herein may be obvious to those skilled in the art, and therefore the true scope and definition of the invention is to be as set forth in the following claims.

We claim:

1. A storm water drainage system anti-microbial device adapted to destroy bacteria in resident water in a sump of a storm water system, said device being buoyant and comprising floatation means for floating said device on the surface of said resident water within said sump and anti-microbial carrier means for carrying an anti-microbial agent;
an anti-microbial agent;
said anti-microbial carrier means comprising a plurality of carrier members disposed below said floatation means, said carrier members comprising depending strip members having distal ends; and
weight members attached to said distal ends of at least some of said strip members

2. The device of claim 1, wherein said anti-microbial agent is adhered to said carrier members.

3. The device of claim 1, wherein said anti-microbial agent is retained within said carrier members.

4. The device of claim 1, further comprising an anchor.

5. The device of claim 1, further comprising a tether.

6. The device of claim 1, wherein said at least one carrier member is composed of a material that filters hydrocarbons.

7. The device of claim 1, wherein said ends of said strip members are joined by connector means.

8. The device of claim 1, wherein said anti-microbial agent is not dispersed into said resident water.

9. A storm water system anti-microbial device adapted to destroy bacteria in resident water in a sump of a storm water system, said device comprising anti-microbial carrier means for carrying an anti-microbial agent, wherein said anti-microbial agent does not disperse into water;
an anti-microbial agent;
said anti-microbial carrier means comprising a plurality of depending strip members having distal ends; and
weights attached to said distal ends of at least some of said strip members.

10. The device of claim 9, wherein said anti-microbial carrier means is composed of a material that filters hydrocarbons.

11. The device of claim 9, wherein said ends of said strip members are joined by connector means.

12. The device of claim 9, further comprising a tether.

13. The device of claim 9, further comprising floatation means for floating said anti-microbial carrier means.

14. The device of claim 13, said floatation means comprising an anti-microbial agent.

15. The device of claim 14, wherein said floatation means is composed of a material that filters hydrocarbons.

16. The device of claim 9, further comprising a mounting member.
